(19) United States
(12) Patent Application Publication
(10) Pub. No.: US 2009/0164387 A1
(43) Pub. Date: Jun. 25, 2009

(54) SYSTEMS AND METHODS FOR PROVIDING SEMANTICALLY ENHANCED FINANCIAL INFORMATION

(75) Inventors: Jef R. ARMSTRONG, Princeton, NJ (US); Andrew J. COHEN, Flemington, NJ (US); Jaime L. GOMEZJURADO, Jersey City, NJ (US); Raymond W. KULBERDA, Kendall Park, NJ (US); Dhananjay D. MAKWANA, North Brunswick, NJ (US); Jeffrey D. MERSHON, Lambertville, NJ (US)

Correspondence Address: WILMERHALE/NEW YORK, 399 PARK AVENUE, NEW YORK, NY, 10022, US

(73) Assignee: SEMANDEX NETWORKS INC., Princeton, NJ (US)

(21) Appl. No.: 12/339,506

(22) Filed: Dec. 19, 2008

Related U.S. Application Data
(63) Continuation-in-part of application No. 12/148,177, filed on Apr. 17, 2008.
(60) Provisional application No. 61/008,211, filed on Dec. 19, 2007.
(60) Provisional application No. 60/923,814, filed on Apr. 17, 2007.

(51) Int. Cl. G06Q 40/00; G06F 17/27; G06T 11/20

(52) U.S. Cl. 705/36 R; 704/9; 345/440; 705/37

(57) ABSTRACT

Systems and methods for providing semantically enhanced financial information are provided. Semantic information integration and computing technologies may be utilized to create and maintain an up-to-date semantic graph encapsulating with nodes and links the business associations among companies, assets, and financial instruments in an industry. The systems and methods provide and use an up-to-date knowledge map for an industry in which an entity, such as a company, operates.

### CROSS-REFERENCE TO RELATED APPLICATION

The application is a continuation-in-part of U.S. patent application Ser. No. 12/148,177, filed Apr. 17, 2008, which claims the benefit under 35 U.S.C. §119(e) of U.S. Patent Application No. 60/923,814, filed Apr. 17, 2007, each of which is hereby expressly incorporated by reference herein in its entirety. This application also claims the benefit under 35 U.S.C. § 119(e) of U.S. Provisional Patent Application No. 61/008,211, filed Dec. 19, 2007, which is hereby expressly incorporated by reference herein in its entirety.

This application is related to U.S. patent application Ser. No. [______], filed Dec. 19, 2008 with Attorney Docket Number 0111785-00137 US2 and titled “SYSTEMS AND METHODS FOR PROVIDING SEMANTICALLY ENHANCED IDENTITY MANAGEMENT,” which is hereby expressly incorporated by reference herein in its entirety.

### TECHNICAL FIELD

The disclosed subject matter relates to systems and methods for the management of semantically enhanced financial information by providing on-demand access to relevant portions of a semantic graph of data distributed among semantic servers.

### BACKGROUND

Financial professionals involved in trading financial instruments depend on the real-time flow of information to assess their positions and trades. Empirical research in efficient markets has shown that for highly liquid instruments the markets move very rapidly in assessing the impact of news directly related to the issuing company. The out performance of less liquid small cap stocks and studies on the effect of information diffusion across the supply chain show that investors have a harder time identifying and assessing news for which there is no direct relationship to the security being traded. Even in those cases when there is a one degree of separation between the company of interest and the news, such as when a customer company or an industry competitor announces news that change the status quo the markets take a long time to absorb the news.

### SUMMARY

Systems and methods for providing semantically enhanced financial information are provided. Semantic information integration and computing technologies may be utilized to create and maintain up-to-date knowledge maps encapsulating with nodes and links the business associations among companies, assets, and financial instruments in an industry. The disclosed systems and methods provide and use an up-to-date knowledge map for an industry in which an entity, such as a company, operates. The disclosed semantic computing server and network of servers facilitates the updating.

In some embodiments, a semantically enhanced financial information system providing a network semantic graph including concept instances and relations between the concept instances is provided. The system includes a plurality of semantic servers in communication with each other and with distributed sources. Each of the plurality of semantic servers includes a first interface for receiving financial information from a market data service, a second interface for receiving semantic data including semantically descriptive annotations from the distributed sources and other ones of the plurality of semantic servers, a processor programmed to process the semantic data based on the semantically descriptive annotations of the semantic data to form a local semantic graph that associates the concept instances with each other using the relations and integrate the financial information with the local semantic graph to enable tracking at least one entity and at least one instrument and relationships to other entities and instrument that may financially affect the at least one entity and the at least one instrument and memory for storing the local semantic graph. Each local semantic graph of each of the plurality of semantic servers includes a portion of the network semantic graph distributed across the plurality of semantic servers.

In some embodiments, a semantically enhanced financial information server storing a local semantic graph including concept instances and relations between the concept instances is provided. The semantic server includes a first interface for receiving financial information from a market data service, a second interface for receiving data including semantically descriptive annotations from distributed sources and other ones of the plurality of semantic servers, a processor programmed to process data based on the semantically descriptive annotations of the data to form the local semantic graph that associates the concept instances with each other using the relations and integrate the financial information with the local semantic graph to enable tracking at least one entity and at least one instrument and relationships to other entities and instrument that may financially affect the at least one entity and the at least one instrument, and memory for storing the local semantic graph, where the local semantic graph includes part of a network semantic graph distributed among a plurality of semantic servers.

In some embodiments, a method for providing at least one client access to a network semantic graph distributed among a plurality of semantic servers wherein the network semantic graph includes concept instances and relations between the concept instances is provided. The method includes receiving first data including semantically distributed annotations from distributed data sources in communication with the plurality of semantic servers, based on the first data including the annotations, linking the concept instances using the relations, storing the concept instances and relations as a local semantic graph including a part of the network semantic graph, receiving financial information from a market data service or another one of the plurality of the semantic servers, integrating financial information with the local semantic graph to enable tracking at least one entity and at least one instrument and relationships to other entities and instrument that may financially affect the at least one entity and the at least one instrument, creating at least one subscription of interest over the network semantic graph in response to a request from the at least one client, collecting second data from the distributed data sources based on the at least one subscription, semantically annotating the second data, updating the local semantic graph based on the semantic annotation, and sending alerts to the at least one client based on updates to the local semantic graph matching the at least one subscription of the at least one client.

In some embodiments, a system for providing a semantic event-driven application for managing information affecting the value of at least one entity and at least one financial instrument related to the at least one entity using a semantic computing application server is provided. The system includes a mechanism to create a semantic graph encapsulating the at least one entity and the related at least one financial instrument and the relationships to other related entities, a second mechanism allowing a plurality of information sources to communicate with the system to enhance the semantic graph when new information about the at least one entity and the related at least one financial instrument is found, an alerting mechanism to inform users when news that may affect the at least one entity or the related at least one financial instrument is received, and an action mechanism enabling the users to define what actions to take in response to the received news.

### BRIEF DESCRIPTION OF THE DRAWINGS

FIG. 1 illustrates an overview of a system for implementing some embodiments of the disclosed subject matter.

FIG. 2 illustrates the interconnection of a plurality of semantic servers in accordance with some embodiments of the disclosed subject matter.

FIG. 3 is a flow diagram showing one example of the semantic server in accordance with some embodiments of the disclosed subject matter.

FIG. 4 illustrates an overview of a system for implementing the semantic server components for some embodiments of the disclosed subject matter.

FIG. 5 is a flow diagram showing some embodiments of event management within the semantic server of some embodiments of the disclosed subject matter.

FIG. 6 illustrates a knowledge map that represents the relationships among various companies in accordance with some embodiments of the disclosed subject matter.

FIG. 7 illustrates an semantic computing application servers serving as a correlating piece in a larger network that includes news and financial information data sources in accordance with some embodiments of the disclosed subject matter.

FIG. 8 illustrates an example of relationships that a semantic application would traverse in accordance with some embodiments of the disclosed subject matter.

### DETAILED DESCRIPTION

In the following description, specific details are set forth regarding the systems and methods of the disclosed subject matter and the environment in which the systems and methods may operate, etc., in order to provide a thorough understanding of the disclosed subject matter. It will be apparent, however, to one skilled in the art that the disclosed subject matter may be practiced without such specific details. In other instances, well-known components, structures, and techniques have not been shown in detail to avoid unnecessarily obscuring the subject matter.

In at least one embodiment, the systems and methods are a software program that uses semantically driven link analysis parameters to analyze connected data and systems in a correlated model. The semantic computing application server is central to the system as the focal point and user interface. The system as a whole can be used for search (programmable and automatic), discovery (of patterns, anomalies, duplicate values, and previous activities) and will provide alerts as specified by the users. The system is an application of a semantic computing application server specifically enhanced for the purpose of financial services information alerting, search and discovery. Due to the flexibility of this system it is multi-faceted and can be used in multiple models. The models presented in the figures are examples of one or two possible models in a multitude of modeling options.

In some embodiments, a high performance system is provided that includes a semantic event-driven application for organizing, keeping track of, and acting on information affecting the value of an asset (e.g. real-estate, commodities, etc.), company or industry and the financial instruments (e.g. stocks, bonds, options, mortgage backed securities, CDOs, etc.) that take their value from them. Some embodiments of the system include three elements: i) a mechanism to create a knowledge map that encapsulates the assets, companies, industries and financial instruments being followed and the relationships to other entities that matter to them, ii) a mechanism to allow all types of information sources to connect to the system so that they can enhance the knowledge map when new information about the subjects of interest is found, and iii) an alerting and action mechanism that lets users know when news that may affect the assets, company, industry or financial instrument they are following is received, and lets users define what actions to take (e.g., do nothing, start a trade automatically, send to another analytical application, etc.)

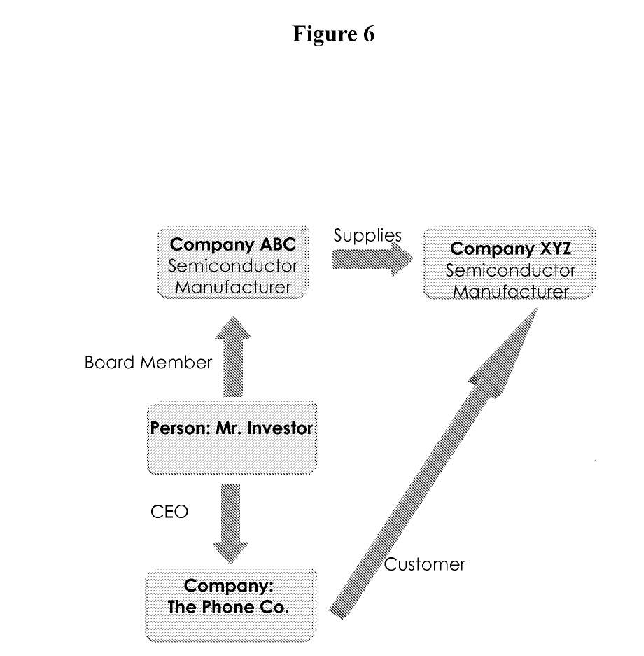

In another embodiment, the systems and methods enable the user to create a knowledge map of the ecosystem of a company or industry he/she is interested in using a semantic computing application server. This knowledge map represents the relationships among the different components of the ecosystem. For instance, ABC is a company that is a supplier to the company XYZ, and they are both semiconductor companies. Moreover, Mr. Investor is on the Board of Directors of ABC, and is the CEO of The Phone Company who buys products from XYZ. The first sentence indicated that XYZ and ABC are both companies, and their industry is semi-conductors, and it shows the relationship between the two (supplier). (See FIG. 6). The second sentence establishes the relationships between a person and the other companies. The semantic computing application servers allows these relationships to be created either automatically by the system through the analysis of news and regulatory filing information or manually through user input. Depending on the size of the knowledge map thus created or the level of security among users of the system one or more semantic computing application servers may be used. If more than one, the system can be designed as a network of semantic computing application servers.

The systems and methods can be primarily triggered by news data, regulatory filings, government and industry reports and information entered by users. The system connects to any number of news feeds public and private such as newswires, RSS feeds for online news sources, blogs, Securities and Exchange Commission (SEC) mandated filings, etc. Some of these may be structured data sources, meaning their metadata is readily available, or they may be unstructured, there is no metadata available.

To generate semantically meaningful metadata from unstructured text the system performs concept and relation extraction as follows. The approach starts with shallow language processing techniques that perform part of speech tagging, chunk parsing, and entity recognition. A process called “gazetteer matching” performs a direct comparison of terms it finds in a document with the instance values associated with the name property of specified concepts—for example—the name property of companies. The actual “gazetteer” is the semantic graph in itself. When a company in a document matches a company instance in the semantic graph, a [Mentions] relation is created between the document instance and the company instance. This process works for any specified concept type, and although useful, is limited to matching existing concept instances having well-defined, unique names (generally these are ‘Proper’ names). The semantic server performs deeper semantic processing that is contextual or relational in nature. Relations are handled in a similar fashion, and so we can extract the semantic representation of phrases such as: Goldman Sachs [Owns] MSFT shares. Users can annotate semantic entities and relationships and link them to the semantic graph. Users' contributions enrich the semantic graph and allow the system to learn and further improve its unstructured text processing capabilities.

The metadata is then matched against the knowledge map to find out whether the data received matches any of the entries in the map. If this is the case the semantic computing application server takes this information and provides further analysis—it will link the data received to the matching information element in the knowledge map, and may create new relationships and new information elements based on the information received. The knowledge map will thus be enhanced by this information, and the results can be displayed in any of a number of appropriate formats: semantic graph display, map, picture, reports, etc.

The systems and methods can forward the results of matches to interested users as alerts through a variety of mediums as chosen by the user or user agency. Moreover, the system enables users to instruct the system to take other actions such as place buy or sell orders, send to another system for further processing, etc., once a match is made.

Compared to existing financial information applications and services, the systems and methods provide users timely information that affects or may affect the assets, companies, industries and financial instruments they follow directly or indirectly. Furthermore, it is able to provide users with a clear view of counter-party risk as defined by the level of exposure that an individual firm, an industry or the economy as a whole has with respect to one of its participants. Moreover, it can do so by tracking any number of data sources, and is not limited to the type of location of the source. So, while today most users are confined to receiving news that mention only the company or industry of interest from a single news aggregator (e.g., Bloomberg, Reuters, Thomson), the system allows users to receive information that mentions not just the company or industry directly, but also, those companies and industries that indirectly affect the performance of the company or industry of interest. And it does so by following any number of news sources, including existing news aggregators.

### Example System

A semantic server can allow users to capture, annotate, link and share information based on semantic annotations on the data expressed on a common knowledge representation, called ontology. Semantic adaptors can be used to interface, for example, SQL databases, RSS feeds, Web Services, Flat Files, Web Pages (forms based posts), and real-time tracks and add or map semantically descriptive labels to the data. Semantic servers can also capture user-generated content.

In some embodiments, clients can access the semantic server by using various systems, such as, for example, a web browser or other client interface software. Applications can access the semantic server via application programming interfaces. Users and applications of a semantic server can be collectively called clients. Clients can create semantic server pages for concept instances represented in the semantic server as a semantic data model or ontology including, for example, individuals, organizations, places or events that are of interest to them. These concept instance pages can be linked through relationships declared in the ontology. The semantic server can store these concept instances and relations as nodes and edges in a semantic graph.

Clients can specify subscriptions of interest over data in the semantic graph. Based on those subscriptions, the semantic server can automatically collect the latest information from data sources coupled to it. Once the collected data is semantically annotated, it can be organized and correlated with previous data in the semantic graph. As the semantic graph changes, the semantic server can alert clients when new information comes in that match their subscriptions. The semantic servers can use commodity-computing servers and can be instantiated anywhere on a private network (intranet) or the public internet.

In some embodiments, data scalability can be improved by maintaining the distributed nature of information or copying all global information into a central repository. One way to manage the scalability issue is to use a “divide and conquer” approach where each semantic server can be specialized to subscribe to certain sections of the semantic graph and persists locally just the data with which it is in communication. Semantic servers can temporarily replicate portions of other server's semantic graphs, and then age/delete that data depending on usage by local consumers. This can provide global reach across all networked servers regardless of, for example, which server the client is locally accessing.

In some embodiments, systems, methods, and media to provide on-demand access to relevant portions of a semantic graph distributed among semantic servers and to manage the size of a semantic graph at each semantic server are provided.

A semantic server can receive data from distributed sources coupled to a plurality of servers. As data enters a semantic server, it can be processed based on its semantically descriptive annotations, forming a semantic graph that associates concept instances such as people, organizations, places and events together following a common knowledge representation or ontology. Because the associations are semantic and follow an ontology, a semantic server can know how various information elements are associated with each other.

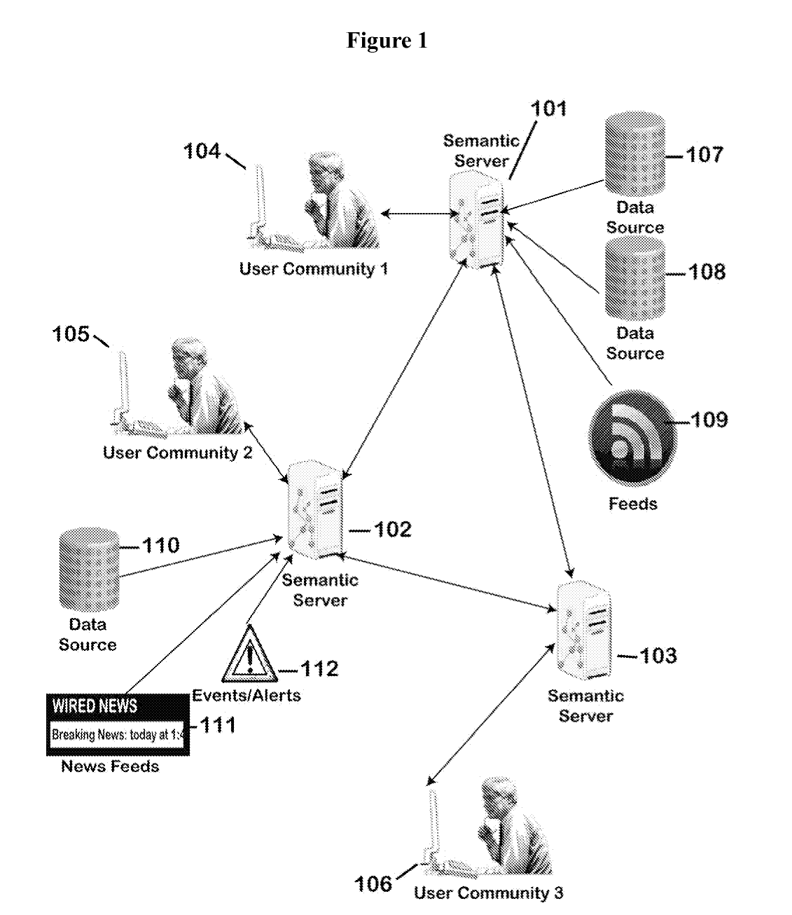

Shown in FIG. 1 is a network of semantic servers 101, 102 and 103 in accordance with some embodiments. Each of the servers 101, 102 and 103 can include a semantic graph. A semantic graph, also known as a relational data graph or attributed relational graph, can be a data structure that encodes relationships as typed links between a pair of typed nodes. It can be a network of heterogeneous nodes and links. The nodes and link types can be related through an ontology (also known as a schema) that can include concept instances such as nodes and relations as edges. The semantic graph can be a data structure that each semantic server maintains in a relational database. In some embodiments, an example of a semantic graph can be the Internet Movie Database where the nodes can be persons (actors, directors, etc.), movies, studios, and awards, among others. In this example, each node can have a type (e.g., movie, director, producer, etc.). Each node can also be labeled with one or more attributes identifying the specific node (e.g., Shrek, Titanic, Airplane, etc.) or providing additional information about the node (e.g., gross revenues, release date, runtime, etc.). Links can also have types, for example, the (person->movie) link can be of type “acted-in” or “directed.” Finally, links can also have attributes, for example, the link “acted-in” can have an attribute “year” having the value “in 2003.”

In some embodiments, not every server needs to have records of all data within its semantic graph at the same time, so replicating the entire semantic graph across all semantic servers may not be desirable. In order to provide global knowledge on-demand to clients 104, 105, 106, without needing to replicate the entire semantic graph at each node semantic servers can subscribe to the portions of the semantic graph that are currently of interest to their clients at any given time. In order to provide these subscription capabilities the semantic server implements a server link interface 409 capable of forwarding portions of the semantic graph across servers on-demand without client intervention. The server link interface 409 can be an application 404 running on each semantic server.

Once a semantic server acquires a portion of the semantic graph from another semantic server, an aging algorithm can be used to age semantic graph portions that have been learned from other semantic servers. For each semantic graph node there can be a field that determines who is the originating or authoritative semantic server. The authoritative semantic server can be responsible for that concept instance as it can be, for example, communicating with the data source or communicating to the client that created that instance. Other semantic servers can “borrow” that concept instance from the parent and then age it.

In some embodiments, a user community can decide to maintain a copy of semantic graph nodes received from other servers because they can be used all the time; in other cases they may have been used a long time ago and not much lately, so they can be deleted and if needed they can be retrieved from the authoritative sever.

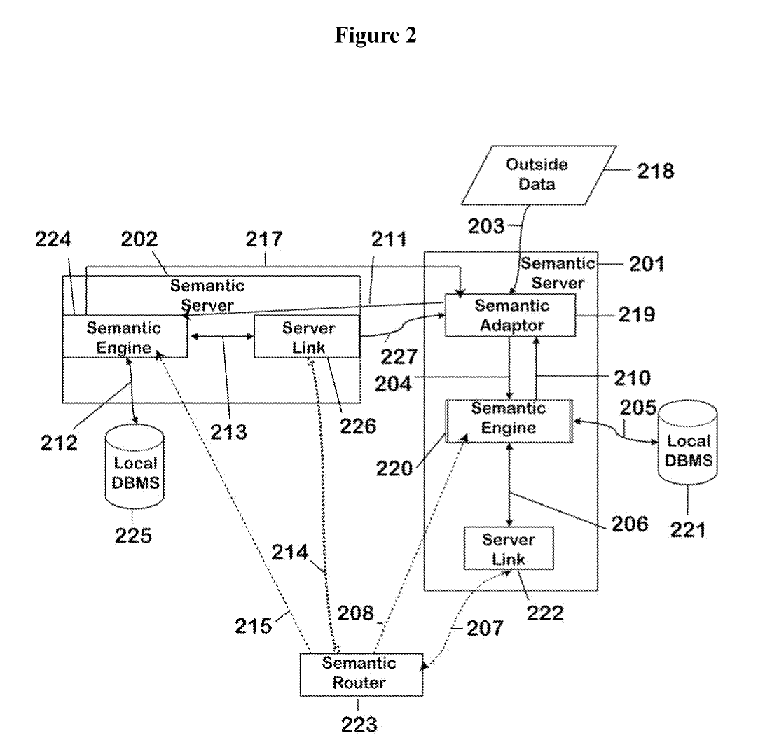

What follows is a detailed description of the operation of a network of semantic servers where the semantic servers maintain a semantic graph that enables clients to receive actionable information as illustrated in FIG. 2 in accordance with some embodiments. Outside data 218 can be input into semantic server 201, either, for example, manually or as a result of an automated process (e.g., RSS feed, sent from another semantic server, etc.). Outside data 218 can include, for example, client data (e.g., from text extraction software, RSS feeds, etc.), and can be, for example, semantically structured. Semantic adapters 219 can process data to conform to the ontology used by the semantic server 201. In some embodiments, multiple adapters can be used, for example, if different data sources provide different types of information; each adapter can be tailored to a particular type of data source. If data already conforms to the ontology used by the semantic server (as it would if delivered from other semantic servers using the same ontology) that data can be passed to the semantic engine 224. In some embodiments, the data can be conformed with the ontology by means of a semantic adapter 219 to map the data meaning to the concepts and relations in the ontology. In some embodiments, the semantic server 201 can be designated to be an originator of outside data for semantic server 202. The semantic engines 220 & 224 can locally store processed information, adding a time-stamp to particular data to determine how recent it is. Semantic server 202 can request additional information (e.g., in response to an event triggered by data from semantic server 201, to optimize response times for future client queries, etc.) stored on other servers. Requests for additional information can be sent using any of a number of techniques, such as, for example, peer-to-peer mode across server link 226, being sent to the semantic router 223 using the server link interface 226, etc.

The information request can be passed to the semantic engines 220 & 224, which can find and compile all relevant information in the local databases 221 & 225 with which the semantic engines 220 & 224 interface. The semantic engines 220 & 224 can retrieve the requested information from the databases 221 & 225. The information retrieved by the semantic engines 220 & 224 at semantic server 201 can be sent to semantic server 202 and input into the semantic adapter 224 in, for example, the same manner that other local data sources are in communication with the semantic server 202.

The semantic server 202 can use a local database management system 221 & 225 to store and retrieve information efficiently. Various database management systems can be used, such as MySQL, Oracle, PostgreSOL, Microsoft SQL Server, etc., and depending on which system or systems are used, slightly different implementations of the processes in the semantic engine 220 & 224 can be used. In some embodiments, a local database can only contain a portion of the overall (distributed) semantic graph. The server link 222 & 226 can implement the interface used to communicate with other semantic servers over a network. It is also possible in some deployment scenarios, for example, to network the servers by means of server link implementations in a peer-to-peer configuration.

A semantic router 223 can be used to provide high performance routing of information across a network that is directing information requests and responses made through the server link interface 222 & 226 to the semantic server 201 & 202 containing the appropriate information. The router, can be, for example the router described in U.S. Pat. No. 7,216,179, entitled “High-Performance Addressing And Routing Of Data Packets With Semantically Descriptive Labels In A Computer Network,” which is owned by the present assignee, and the disclosure of which is expressly incorporated by reference in its entirety herein.

A Semantic Server in Accordance with Some Embodiments

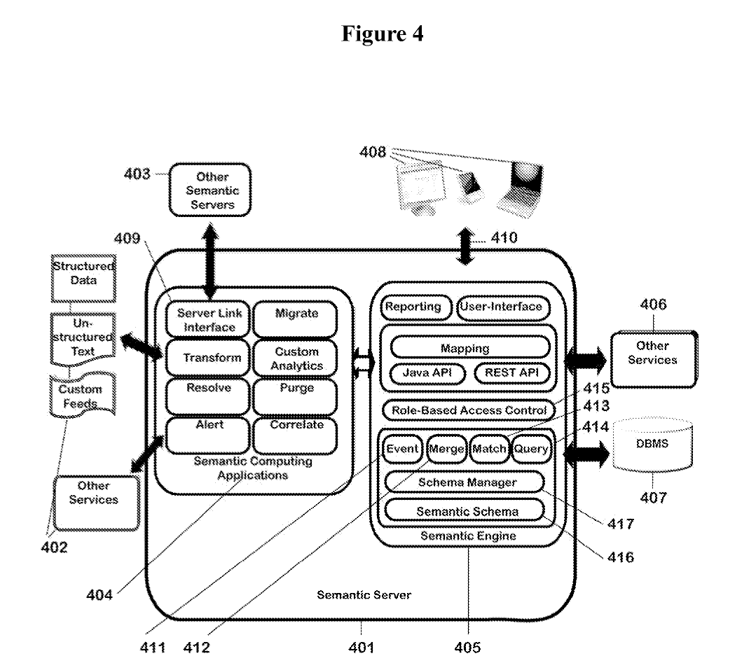

A software architecture of a system in accordance with some embodiments is illustrated in FIG. 4 as an overview of its applications, components, services and interconnected diagrams, includes a semantic engine 405 and a semantic server schema 416.

### Semantic Engine 405

The semantic engine can perform the following functions: data matching 413 combining new data into matching concept instances already in the semantic graph; data merging 412 which merges information across subscriptions; and event management 411, which monitors and responds to changes in the semantic graph; and query 414, for finding information already in the graph.

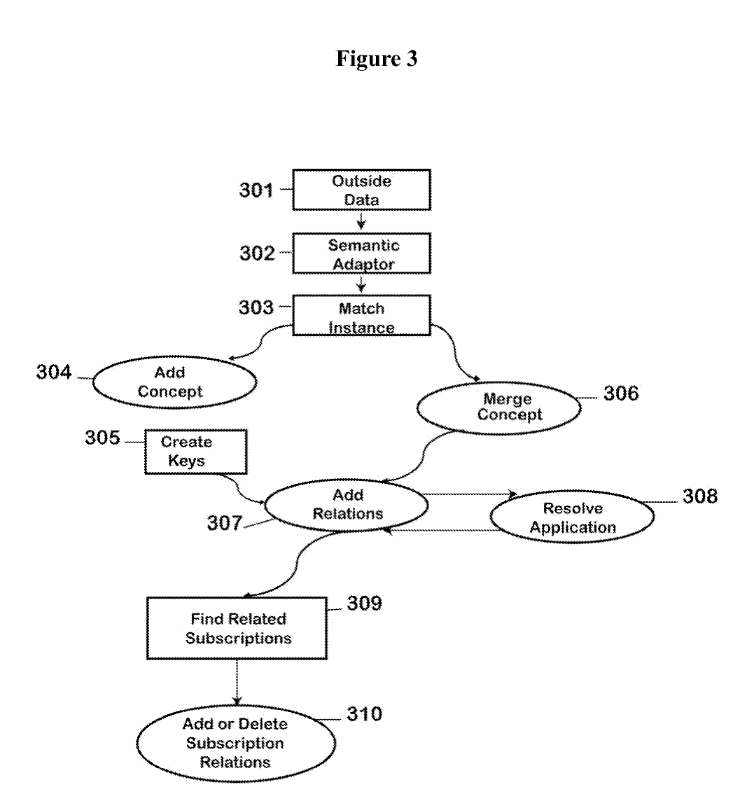

FIG. 3 illustrates a data flow process within the semantic engine impacting upon the semantic graph in accordance with some embodiments. It follows outside data 301 being processed 302-309 and at the subscription level 310. The data can enter the semantic engine 405 through the semantic adaptor 302. Match operation 303 can include inserting and/or updating concept instances, properties and/or relations in the semantic graph. The match process can be governed by rules which can be maintained as part of the schema. If the concept instance is not already in the graph, it can be added through the add concept 304.

Keys 305 can be constructs used by the match engine to determine whether and when new information is merged with existing information. Keys can be composite (e.g., including multiple properties) and have match rules which can include complex and/or fuzzy logic. If the data entering the semantic engine conforms to a concept instance already in the graph, any new information can be added to that concept instance. Keys 305 describe to the matching process 303 which particular properties in the match engine can be updated and the manner in which they can be updated. Based on this process, additional associations 307 can be created and if so can be added to the semantic graph according to the predefined ontology that defines concepts and relations 307. The semantic server can derive additional information not explicitly stored in the semantic graph by means of executing expressions that operate on the semantic graph data. For example, a portion of a semantic graph tracking the details of a phone call: the semantic server can derive a relation between two persons called “CommunicatesWith” having a given strength based on the number of calls involving telephones “OwnedBy” those persons.

The semantic engine can query the graph to determine which currently available subscriptions are related to the new concept instance 309 and what relations have been provided by this process 304, 306 and 307.

The information about relevant subscriptions can be used, along with the logical composition of different subscriptions, to determine whether a concept instance has a relationship with a subscription 310.

A Semantic Server Schema in Accordance with Some Embodiments

The semantic server 401 can employ a client-defined schema 416 to organize information stored within it. The schema 416 can include four components: concepts, properties, attributes and relations.

Concepts can represent persons, places and things in the real world. A concept instance can, for example, represent a single, specific person, such as George Washington, place or thing, or can represent a set of persons, places or things.

Properties can represent descriptive elements of concepts, such as, for example, the color of a person's hair, the latitude of a place, or the weight of an object. Properties can be typed, that is, the kind of data stored in a property is restricted to a specific type, such as integers, real numbers or character strings. Attributes can represent data about properties (metadata), and can be used for a variety of reasons within the semantic server such as tracking the last time a property was updated or specifying where the property will appear on a page in the server's user interface (presentation directives). The schema can support multi-valued properties, so that different sources can, for instance, report different hair color for George Washington if they have different information. This can be used, for example to support collaborative groups. User communities can decide how to handle conflicting information (either manually or automatically). Source attribution can be associated with each piece of information to its source, so, for example, the server can store the fact that Joe Analyst reported the color of George Washington's hair as being white.

Relations can represent meaningful associations between concepts. Relation instances can connect specific concept instances. For example, a relation Is_Married_To between two instances of the concept Person can be used to associate George Washington with Martha Washington. The Is_Married_To relation is not defined between Person and Automobile, for example, because that relation doesn't have meaning in the real world. A relation set can be a mechanism by which similar relations, such as George Washington Is_Married_To Martha Washington, reported by multiple sources, can be grouped together and treated as an entity. Rules for defining how specific relation sets are treated are defined in the schema.

Special Semantic Constructs in the Schema in Accordance with Some Embodiments

Because the semantic server can use the schema to control its operation, certain constructs specific to the operation of the server are included in the schema.

### Schema Manager 417

The schema can be maintained in a semantic graph. Just as the data can have a concept instance for George Washington, the concept Person also exists as a concept instance in the semantic graph. Clients can manipulate the schema through a user interface. Transforming data between different schemas can be handled through the use of applications which modify the data appropriately. Depending on, for example, the implementation of the applications and/or the specific transformation being conducted, the semantic server can continue operation even while the schema is being transformed.

Supporting Evidence in Accordance with Some Embodiments

Concepts in the graph can be used as supporting evidence for other assertions including concept, property and relation instances. For example, an adverse drug event filing can serve as supporting evidence of a relation between a specific compound and contraindication, or an intelligence report can serve as supporting evidence of specific insurgent activity in a specified area. In addition, relations can have additional properties, such as degree and certainty, for specifying the strength, or affinity of two concept instances and the confidence in the relation's existence, respectively. In some embodiments, all data can be attributed to its source, whether it was a human user or data automatically entered through an application.

Subscriptions in Accordance with Some Embodiments

Subscriptions can be created by clients to indicate what they are interested in receiving information regarding and or alerts on. Within the semantic server schema subscriptions can be dynamic sets of concept instances in which each member conforms to some client-specified criteria. For example, a client can create a subscription for all Persons, all Persons having red hair, all Persons who are Members Of any organization, a specific organization, or Persons whose height is greater than 6′, etc. Property and attribute value criteria can include operators, such as equals (=), starts with, contains, greater than, sounds like, etc. Subscriptions in the semantic server can be dynamic, in that, for example, new information can be routed to applicable subscriptions as it enters the semantic server, and a set of concept instances that belongs to a subscription can be constantly maintained. Set membership need not be recomputed each time a client requests the members of a subscription. Complex subscriptions can be created by chaining subscriptions together using logical operators. The section below entitled “Subscription Implementation and Semantic Applications in Accordance with Some Embodiments” can be reviewed for a more complete description of how subscriptions operate as well as their use in decision making processes supported by the semantically organized data.

Role-Based Access Control (RBAC) 415 in Accordance with Some Embodiments

User access privileges as well as concept, property and relation permissions can be stored in the semantic graph, providing fine-grained access control to specific concept, property and relation instances as well as coarser-grained access control based on the schema. In other words, permissions can be established at the concept level (e.g., Person) or on a per-instance basis (George Washington), or at the property (Person.name) or property instance level (George Washington.name). Access control can be managed within the semantic core which prevents unauthorized access.

Semantic Computing Applications 404 in Accordance with Some Embodiments

Semantic applications written to interface with the semantic server are represented in the semantic graph and are managed by system administrators through the user interface. Such applications have access to the event handling process used by the semantic server, which can allow them to dynamically respond to changes in the underlying data. Management can include, for example, stopping and starting applications as well as setting configuration properties.

An Example of a Semantic Computing Application 405 in Accordance with Some Embodiments

Server Link Interface 409 provides network functionality for using semantic information distributed between multiple servers. This interface can implement services to determine the kinds of data available for integration from other servers and allows for the efficient transfer of that information from the database management systems of remote servers into the semantic engine.

Subscription Implementation and Semantic Applications in Accordance with Some Embodiments

Subscriptions can allow clients to be notified of information changes of interest on the semantic graph. Subscriptions can be baselined or can be chained together to create dynamic subscriptions with high-order set constraints. The elements at the intersection of those sets can satisfy the constraints and can be of interest to the clients; as a result, client-defined actions including notification or subsequent processing can be initiated.

Clients can define subscription sets and change them as needed without changing the underlying ontology. For example, a subscription for males taller than 6′ belonging to AAA can be chained with a subscription for people attending a class reunion at a Thomas Jefferson High School. The results at the intersection of both sets are instances of males taller than 6′ belonging to AAA also attending the function. Additionally, this can allow subscriptions themselves to be represented as small schema, providing partially instantiated portions of the semantic graph to match structurally similar subscription schema and create events against this complex subscription type.

Persistent Logical Operations in Accordance with Some Embodiments

Subscriptions (set descriptors) can also be part of the semantic graph, so new content is attached to matching sets or removed from sets when it no longer matches as new information comes into the semantic server. Accordingly, subscriptions can be dynamically updated to reflect the actual state of data.

Examples of Baseline Subscriptions in Accordance with Some Embodiments

All X such that X IsA [typeOfConcept], where typeOfConcept is a class name, or concept name, such as Person, Facility, or Hospital. Subscriptions in the semantic server are always constrained in this manner, thus set membership is always homogenous by type.

All X such that X.propertyname [operator] [value], where property name is an attribute (property) of a concept, such as name, height, or hair color; operator is a comparator function, such as equals, greater than, or less than; which is used to compare the property value of each candidate member to the value provided in the subscription. Examples of this kind of subscription are: Person.height>60″, or Person.name contains ‘smith’.

All X such that X [relation] Y, where relation is a relation that is valid between concepts of type X and concepts of type Y, and Y is a specific concept instance. The relations that are valid between any two concept types are defined in the ontology and enforced by the semantic server. An example of this kind of relation is: Facility LocatedIn Place.name=‘Trenton’. In the semantic server, this subscription will match facilities that are geo-located within the polygon that describes Trenton as well as facilities that have an explicit LocatedIn relation to Trenton.

All X such that X [anyRelation] Y, a variation of the above in which any X that has any kind of relation to Y will be returned.

All X such that X [relation] Set “S”, where set S is a list of members of a subscription.

The certainty with which a property value or relation is known varies, and a semantic server can provide native support for probabilities on both properties and relations. Consequently, we can capture information such as: Person has hair color=“Brown” with =80% certainty, Person IsMemberOf Organization Y with <75% certainty and Person X IsSameAs Person Y with >50% probability.

Dynamic Subscriptions in Accordance with Some Embodiments

In some embodiments, subscriptions can continuously maintain information about the data meeting certain logical criteria and the criteria themselves can also be dynamic. For instance, a subscription can look for all “bird sighting” concepts with relation “near” a specific “Car” concept (e.g., a particular VIN#). This is qualitatively different from subscribing to a list of all bird sightings near a particular location because a car moves. In particular, the location value for the car can be updated at regular intervals, which can automatically trigger re-computation of the concepts that match the subscription at each update. Similar reasoning applies to subscriptions conditioned on time-based relationships (e.g., within 2 weeks of), since set membership depends on a moving variable. By allowing dynamic subscriptions in this way, the semantic server can retain data lost by typical query methods and can allow analysis not only to present states but also of the past development of different concepts.

Using Subscriptions to Abstract Information in Accordance with Some Embodiments

One application of subscriptions, combined with certain kinds of applications interfacing with the semantic server, can be to provide abstracted information about the current state and the development of sets of objects over time. Examples of the abstracted information can include a histogram of the time of day at which a particular event is likely to occur, or the typical duration of a given event. If a new event matches the logical requirement of a subscription but is a poor fit with observed information, this can cause the event to receive more thorough scrutiny. The event's low probability may mark a change in what is considered “typical”. The current nature of subscription information means that events identified as “outside the norm” in this manner are identified quickly enough to enable action to be taken, whereas a query based system may not be able to consistently identify this kind of information as queries retrospectively assemble relevant data.

Semantic Server Interface in Accordance with Some Embodiments

External clients can interact with the semantic server using various application program interfaces to extract data from the server and to insert data into the server and can be used to customize requests for data including any concept, property or relations of interest from the semantic graph on the semantic server. Among the many possible APIs are a Java API and a Representation State Transfer (REST) API. The Java API provides a rich Java-language interface to the semantic server, including event management interface. The API requests and responses can be formatted in several different formats as would be understood by one skilled in the art, which can include but are not limited to XML, JavaScript Object Notation (JSON), Keyhole Markup Language (KML), etc. KML is the format used by Google Earth and Google Maps to manage the display of geographic data in an application. KML uses a tag-based structure with nested elements and attributes and is based upon the XML standard. See http://code.google.com/apis/kml/documentation/for KML documentation.

### Example Enhanced Financial Information System

Some embodiments of the disclosed subject matter provide systems and methods for semantically enhanced financial information. Data-sources and databases which can be integrated into the system include but are not limited to:
News aggregator feeds (e.g. Dow Jones Newswire, Reuters, Thomson, Bloomberg)
Newspaper RSS feeds
Financial and industry blogs and message boards
SEC Filings and reports in free text form and with XBRL markings
Government and NGO (e.g. IMF, World Bank, WTO, etc.) reports
Industry periodicals

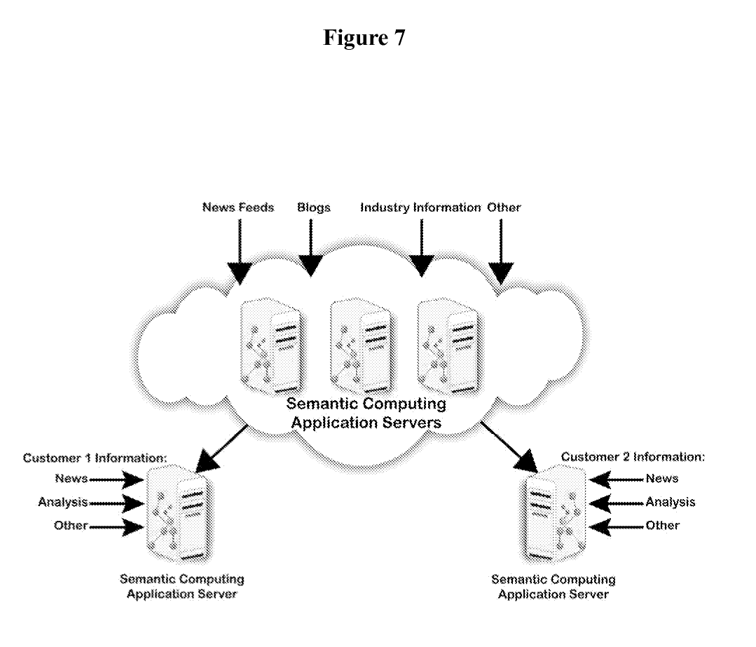

FIG. 7 illustrates an embodiment including the semantic computing application servers, which serves as the correlating piece in a larger network that include news and financial information data sources both structured (databases, XML based documents), or unstructured (free text, news, documents, etc.), and potentially other applications to conduct further analysis (e.g., quantitative models for predicting stock moves), or to place trades (e.g., trading stations ala Bloomberg, Thomson and others).

The system can produce a variety of alerts and responses as varying as the users who access the network. It can provide alerts based upon specific information across all connected users or programs to the system. For example, sell-side analysts may be looking to receive information about companies that they follow directly as an email alert, but only look at information about companies indirectly related to those that they follow on their web-browser. With a semantically enhanced system, a variety of alerts and responses can be provided driven by user needs.

One or more examples of applications for the system follow. There are at least two ways to deploy the system:

As a collaborative/collective intelligence software
Software as a Service (SaaS) hosted or on-premises offering
Provides the user with all the system features: real-time alerts based on linked information, connection to user databases and paid and unpaid market data feeds, etc. The owner of the system is the user and he/she is responsible for maintaining and populating the map of the ecosystem they are interested in

Collaborative intelligence market data service (a linked Bloomberg)
SaaS offering that provides users access to the semantic graph for their companies/securities of interest updated automatically with information from the major news providers and thousands of local and international RSS news feeds, blogs, industry web-sites, etc.
User organizations can set up their own semantic graphs that will be updated automatically whenever a new piece of information is available, and it can also be updated by users in the organization with their proprietary information;
The semantic computing application server graph can be hosted or located at the customer premises.

Example User 1 Description
Objective: To find information regarding a company and/or market that can influence trading in the financial instruments tied to the company.
Most Sought After Information: Most financial professionals already receive information from the largest news services—finding top-level information affecting a company directly and carried on major news services is priced into the market almost instantaneously. Less obvious information such as information affecting an important customer/supplier in which the trader needs to connect the dots are not reflected immediately by the market and represent an opportunity for the trader. Similarly, news of layoffs at a local plant, which is carried only by the local newspaper, takes longer to discover using current market data information services. Information regarding operations outside of the US is also often missed by the newswires and hence by the traders. In addition, information affecting small companies and divulged through blogs, technical magazines, etc. also takes time to get disseminated in the market.
Timing: (Minutes to Hours.) For new information, ideally to find the information prior to or at the very least no later than the market discovers it. For archived information, find the obvious and non-obvious relationships affecting the company/financial instrument.
Action: Trade or provide information to clients.
Usage: Keep track of new items of information that relates to the assets, companies and sectors under coverage; rapidly understanding its impact on financial instruments and potential secondary or tertiary effects on other companies/financial instruments. Take advantage of the knowledge base garnered over time by the community of traders, analysts, sales-traders, sales people and capital markets to more rapidly understand a how a piece of information can affect trading in a company's financial instruments.
Current means of accessing information: Newswires (through Reuters, Bloomberg, Thomson, or like information source), company management, financial filings, the web, Lexis/Nexis® (and other like services), clients and traders.
Type of user: Needs to analyze and react fast for the information to be of value. Has limited time, but is willing to spend time with tools that provide him/her an edge.

Example User 2 Description
Objective: To verify whether individual companies are complying with existing regulations, and to understand and track the health of individual firms and industry sectors to prevent or mitigate the risks to the economy.
Most Sought After Information: Regulators, the Federal Reserve, the Treasury Department and others already receive a wealth of information from market participants—most of this information gives regulators a first order understanding of the financial position of a firm. Under normal circumstances, this information and other based on statistical risk models provide adequate indicators of the level of risk facing firms in the financial markets. Unfortunately, these statistical models break down under conditions of stress, as it was clearly evident in 1998 with the collapse of Long Term Capital Management, and even more spectacularly in 2007 and 2008 resulting in the near collapse of the financial system. What is missing is a better understanding of the risks generated by the interconnected nature of today's global financial markets. Mapping these interdependencies by finding out and keeping track of changes in institutional holdings and the assets and instruments underlying them is necessary to understand a firms' second, third or higher order exposure to other firms and their impact to the overall health of the financial markets. While firms can be required to disclose their holdings, regulators would also need to keep track of market and economic news that can affect those holdings. This continually updated knowledge map would allow regulators and government agencies to understand the risks posed by individual market participants and the impact of public policy.
Timing: (Days-months) No immediate action is generally required or expected; rather policy makers and regulators need as much information as possible to make sure their actions are effective.
Action: Enact regulatory policies, preempt problem areas by breaking up firms, injecting liquidity, or decide who to bail-out and who to let fail.
Usage: Keep track of new items of information that relates to the holdings: assets, financial instruments, leverage, etc. of companies under coverage. Within a reasonable timeframe understand the impact of those changes on the health of the economy and whether individual firms are complying with regulations. Take advantage of the knowledge base garnered over time by other regulatory, and government agencies to more rapidly understand a how a piece of information can affect the nation's economy.
Current means of accessing information: Regulatory filings, Newswires (through Reuters, Bloomberg, Thomson, or like information source), company management, economic reports, the web, Lexis/Nexis® (and other like services).
Type of user: Regulators and government officials. Can spend days, week analyzing information and enact policy or take corrective actions in a matter of weeks and months.

In one example, proprietary channel checks by PC a analyst show heavy markdowns being offered by top two PC firms, for example HP and Dell. The process: Analyst enters the information in the system tying the data to HP and Dell. The outcome: Manufacturer, distributor and component analysts receive an alert regarding the new piece of research. They immediately assess the impact of lower margins at the top of the PC food chain and analyze how it propagates down to the companies under their coverage. They are able to make a call on their stocks and advertise it to the market (if sell-side analysts), or inform PMs (portfolio managers) or traders if buy-side analyst. The new information rapidly becomes a win for the entire franchise.

In another example, news of a strike at a semiconductor plant in Taiwan is published in local papers—manufacturer provides specialized chips used in top-of-the-line cell phones. The process: When a news item is published through RSS feed, the semantic computing application server processes the item and generates alerts regarding the company directly affected and those companies in its supply chain including cell phone providers Nokia, Erickson, Motorola, etc. The outcome: PMs recognize the potential impact and instruct their analysts to quantify the exposure of companies to the strike and the potential to trade on the information.

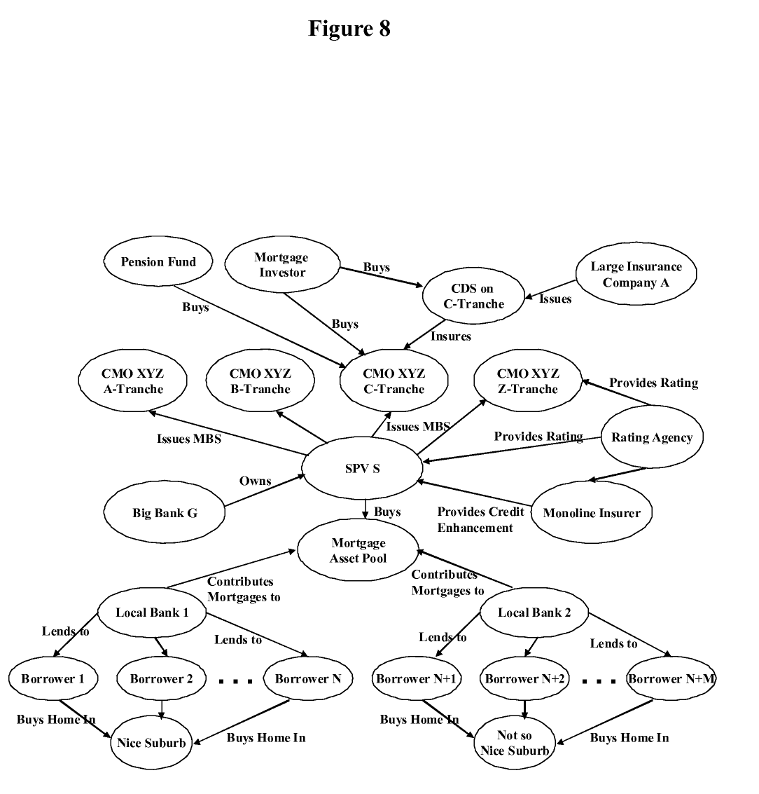

In another example, last foreclosure numbers in California show a sharp increase. Mortgage securities and financial services stocks with exposure to the state loose an average of 10% of their value after the report is published. The process: When the report is circulated prior to circulation, the numbers are imported directly into the semantic computing application through one of its connectors. The semantic server processes the item and generates alerts regarding the financial services companies directly affected by looking at those companies that have large holdings of mortgage related securities exposed to California real-estate market: local banks, mono-line insurers, real-estate hedge funds, and proprietary desks at investment and commercial banks are among them. FIG. 8 is an example of the relationships that the semantic application would traverse to identify all the different players affected by problems in the California mortgage market. The outcome: FDIC officials recognize the potential impact and instruct their staff to quantify the exposure of bank holding companies to California real-estate market. They rapidly assess what companies may be at risk if the markets continue deteriorating, and estimate their capital needs, probability of default, and impact on the overall market and on the FDIC and Treasury. They then work with the management of the affected banks, the Treasury and the Fed to come to an agreement on what institutions can merit potential direct intervention because of how exposed other institutions are to them, which ones should be forced to increase their capital base or find a buyer and which ones do not merit any intervention.

Real-time integration of traditional and non-traditional finance, industry and product data sources allows users to keep track of news flow across the supply chain of a company. Currently users must access each one of these sources separately making it difficult to keep track of the information that can affect a stock directly or indirectly.

Alerts can be set to transcend the boundaries of analyst coverage, so everyone in a franchise can benefit from the information shared by the analyst entering it. The system sends all alerts automatically thus eliminating the de-facto human bottleneck that requires one analyst to alert all the other affected analysts of his/her findings.

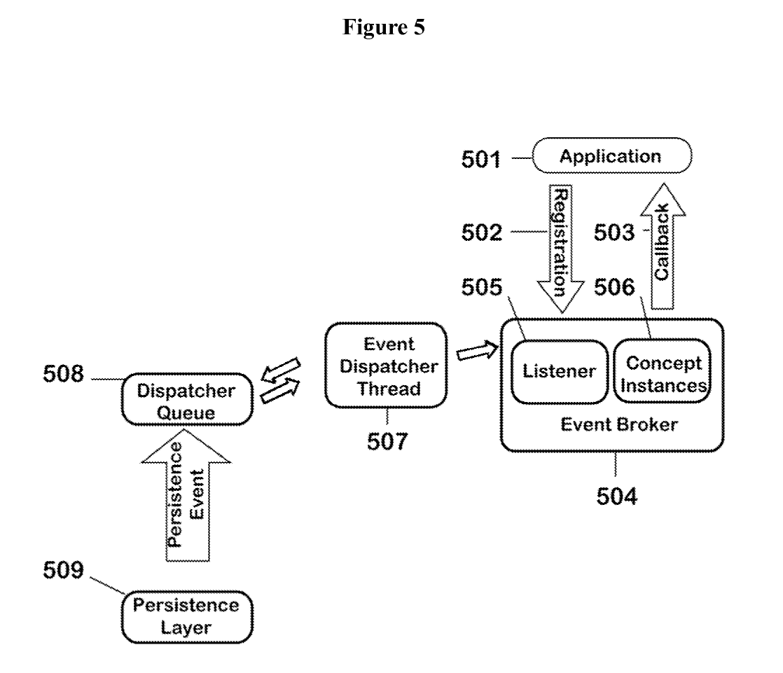

Various servers and clients disclosed herein, can include, for example, among other things, processors, displays, input/output devices, and memories, which can be interconnected. In some embodiments, the memories contain storage devices for storing programs and/or software modules for controlling the processors or performing methods, for example, those methods described herein with reference to FIGS. 1-8. In addition, although some embodiments are described herein as being implemented on a client and/or a server, this is only illustrative. Various components of some embodiments of the disclosed subject matter can be implemented on any suitable platform.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention.

What is claimed is:

1. A semantically enhanced financial information system providing a network semantic graph comprising concept instances and relations between the concept instances, the system comprising:
a plurality of semantic servers in communication with each other and with distributed sources, wherein each of the plurality of semantic servers comprises:
a first interface for receiving financial information from a market data service;
a second interface for receiving semantic data including semantically descriptive annotations from the distributed sources and other ones of the plurality of semantic servers;
a processor programmed to:
process the semantic data based on the semantically descriptive annotations of the semantic data to form a local semantic graph that associates the concept instances with each other using the relations; and
integrate the financial information with the local semantic graph to enable tracking at least one entity and at least one instrument and relationships to other entities and instrument that may financially affect the at least one entity and the at least one instrument; and
memory for storing the local semantic graph;
wherein each local semantic graph of each of the plurality of semantic servers comprises a portion of the network semantic graph distributed across the plurality of semantic servers.

2. The system of claim 1, wherein the at least one entity comprises at least one of assets, companies, and industries.

3. The system of claim 1, wherein the at least one instrument comprises financial instruments.

4. The system of claim 1, wherein the processor is further programmed to issue an alert to at least one of the distributed sources based on the network semantic graph, a financial profile, and the financial information.

5. The system of claim 1, wherein the processor is further programmed to trade a security based on the network semantic graph, a financial profile, and the financial information.

6. The system of claim 1, wherein the market data service includes at least one of a news aggregator feed, a newspaper RSS feed, a financial webpage, a government data source, and an online periodical.

7. The system of claim 1, wherein the first interface and the second interface comprise the same physical interface.

8. The system of claim 1, wherein processors of some of the plurality of semantic servers are programmed to update the network semantic graph while processors of others of the plurality of semantic servers are programmed to operate on the network semantic graph.

9. The system of claim 1, wherein the processor is further programmed to take at least one action in response to user instructions, wherein the at least one action includes at least one of placing a buy order, placing a sell order, and sending an alert to at least one of another user or another system for further processing.

10. The system of claim 1, wherein the financial information includes unstructured text and wherein the processor is further programmed to generate semantically descriptive metadata from the unstructured text.

11. The system of claim 10, wherein the processor is further programmed to match the metadata against the local semantic graph to determine whether the semantic data received matches at least one entry in the local semantic graph.

12. The system of claim 11, wherein the processor is further programmed to link the semantic data received to a matching information element in the local semantic graph to create new relationships and new information elements based on the data received when the data received matches at least one entry in the local semantic graph thereby enhancing the local semantic graph.

13. The system of claim 12, wherein results of the linking can be displayed in one or more formats including semantic graph display, map, picture and reports.

14. The system of claim 1, wherein the processor is further programmed to extract concept and relation extraction using shallow language processing.

15. The system of claim 14, wherein the shallow language processing includes at least one of part of speech tagging, chunk parsing, and entity recognition.

16. The system of claim 1, wherein the processor is further programmed to perform a comparison of terms found in a document with the instance values associated with a name property of specified concepts.

17. The system of claim 1, wherein the processor is further programmed to receive input from at least one user in an organization and to update the semantic graph with at least one of proprietary information, public information and commercial information based on the received input.

18. A semantically enhanced financial information server storing a local semantic graph comprising concept instances and relations between the concept instances, the semantic server comprising:
a first interface for receiving financial information from a market data service;
a second interface for receiving data including semantically descriptive annotations from distributed sources and other ones of the plurality of semantic servers;
a processor programmed to:
process data based on the semantically descriptive annotations of the data to form the local semantic graph that associates the concept instances with each other using the relations; and
integrate the financial information with the local semantic graph to enable tracking at least one entity and at least one instrument and relationships to other entities and instrument that may financially affect the at least one entity and the at least one instrument; and
memory for storing the local semantic graph, the local semantic graph comprising part of a network semantic graph distributed among a plurality of semantic servers.

19. The semantically enhanced financial information server of claim 18, wherein the at least one entity comprises at least one of assets, companies, and industries.

20. The semantically enhanced financial information server of claim 18, wherein the at least one instrument comprises financial instruments.

21. The server of claim 18, wherein the processor is further programmed to issue an alert to at least one of the distributed sources based on the network semantic graph, a financial profile, and the financial information.

22. The server of claim 18, wherein the processor is further programmed to trade a security based on the network semantic graph, a financial profile, and the financial information.

23. The server of claim 18, wherein the market data service includes at least one of a news aggregator feed, a newspaper RSS feed, a financial webpage, a government data source, and an online periodical.

24. The server of claim 18, wherein the first interface and the second interface comprise the same physical interface.

25. A method for providing at least one client access to a network semantic graph distributed among a plurality of semantic servers wherein the network semantic graph comprises concept instances and relations between the concept instances, the method comprising:
receiving first data including semantically distributed annotations from distributed data sources in communication with the plurality of semantic servers;
based on the first data including the annotations, linking the concept instances using the relations;
storing the concept instances and relations as a local semantic graph comprising a part of the network semantic graph;
receiving financial information from a market data service or another one of the plurality of the semantic servers;
integrating financial information with the local semantic graph to enable tracking at least one entity and at least one instrument and relationships to other entities and instrument that may financially affect the at least one entity and the at least one instrument;
creating at least one subscription of interest over the network semantic graph in response to a request from the at least one client;
collecting second data from the distributed data sources based on the at least one subscription;
semantically annotating the second data;
updating the local semantic graph based on the semantic annotation; and
sending alerts to the at least one client based on updates to the local semantic graph matching the at least one subscription of the at least one client.

26. The method of claim 25, further comprising issuing an alert to at least one of the distributed data sources based on the network semantic graph, a financial profile, and the financial information.

27. The method of claim 25, wherein the market data service includes at least one of a news aggregator feed, a newspaper RSS feed, a financial webpage, a government data source, and an online periodical.

28. A system for providing a semantic event-driven application for managing information affecting the value of at least one entity and at least one financial instrument related to the at least one entity using a semantic computing application server, including:
a mechanism to create a semantic graph encapsulating the at least one entity and the related at least one financial instrument and the relationships to other related entities;
a second mechanism allowing a plurality of information sources to communicate with the system to enhance the semantic graph when new information about the at least one entity and the related at least one financial instrument is found,
an alerting mechanism to inform users when news that may affect the at least one entity or the related at least one financial instrument is received; and
an action mechanism enabling the users to define what actions to take in response to the received news.

29. The system of claim 28, wherein the at least one asset includes at least one of real-estate and commodities.

30. The system of claim 28, wherein the at least one entity includes at least one of a company, industry, and at least one financial instrument.

31. The system of claim 28, wherein the at least one financial instrument includes at least one of stocks, bonds, options, mortgage backed securities and CDOs.

32. The system of claim 28, wherein the actions to take include at least one of take no action, start a trade automatically, and send to another analytical application.

33. The system of claim 28, wherein the semantic graph represents the relationships among different components of an ecosystem of the at least one entity, wherein the relationships are created either through the analysis of news and regulatory filing information or through user input.

34. The system of claim 28, wherein the system is implemented on one or more semantic computing application servers.

35. The system of claim 34, wherein the system is implemented as a network when more than one semantic computing application servers is used.
